(19) United States
(12) Patent Application Publication
(10) Pub. No.: US 2025/0347817 A1
(43) Pub. Date: Nov. 13, 2025

(54) CAMERA DISENGAGEMENT SYSTEM

(71) Applicant: Spinal Guides Labs, LLC, Carolina, PR (US)

(72) Inventor: Albert Y. Davydov, Carolina, PR (US)

(21) Appl. No.: 19/276,964

(22) Filed: Jul. 22, 2025

Related U.S. Application Data
(63) Continuation-in-part of application No. 18/847,012, filed on Sep. 13, 2024.
Application No. 18/847,012 is a continuation-in-part of application No. 17/707,153, filed on Mar. 29, 2022, now Pat. No. 12,322,133.
(60) Provisional application No. 63/674,482, filed on Jul. 23, 2024.

(51) Int. Cl. G01T 7/00

(52) U.S. Cl. CPC G01T 7/005

(57) ABSTRACT

Devices, systems and methods are disclosed for calibrating the center of an imaging device, such as a camera, to the center of an X-ray beam projected by a tiltable X-ray generator. The system includes a protractor assembly with a rotatable vertical leg mounted to the X-ray generator, supporting an imaging device maintained at zero tilt relative to an image receptor. Real-time imaging data is transmitted wirelessly to a head positioning system that incorporates artificial intelligence (AI) to detect and align the imaging device center to the X-ray beam center using image recognition. The AI system enables precise, software-based calibration without physical realignment of the patient's head, facilitating accurate and reproducible diagnostic imaging of complex cervical structures, such as the C1/C2 vertebrae. The system also minimizes unnecessary radiation exposure by enabling tighter collimation of the X-ray field.

### PRIORITY

This application claims priority to U.S. Provisional Patent Application Ser. No. 63/674,482, filed Jul. 23, 2024, the contents of which are hereby incorporated by reference in its entirety.

This application is also a continuation-in-part application of U.S. patent application Ser. No. 18/847,012, filed Sep. 13, 2024, which is a continuation-in-part application of U.S. patent application Ser. No. 17/707,153, filed Mar. 29, 2022, now U.S. Pat. No. 12,322,133, the contents of which are hereby incorporated by reference in their entirety.

### TECHNICAL FIELD

The present disclosure relates generally to imaging systems, and more particularly, relates to devices, systems and methods for calibrating a center of an imaging device, such as a camera, directed to a patient's head to a center of an X-ray beam directed to the patient's head while necessary to adjust tilts of an X-ray device relative to the patient head.

### BACKGROUND

Getting a mutual center of an X-ray beam and an imaging device, e.g., a camera, is very important during different X-ray beam tilts required for studying complex anatomies of C1/C2 complex during anterior-posterior imaging. During these studies, X-ray beam tilts are required and, therefore, angle compensation of the camera device is required because the camera device in relation to the X-ray beam controls the patient's face. That creates an X-ray beam center and a camera device center directed at different anatomies from originally intended. Uniting both the X-ray beam center and camera device center before registration of a patient in front of the camera device will provide starting coordinates for the camera image that would correspond to the undistorted and unobstructed needed X-ray view. As described in commonly-owned U.S. patent application Ser. Nos. 17/707,153 and 18/847,012, registration is specific to patient facial points and lines registration, so that the system recognizes that particular patient while positioning the patient next to the X-ray machine. These lines are used for orthogonal controlled positioning for highly technique sensitive Atlanto Axial stabilizing ligaments X-ray imaging which can be done only with use of diagnostic X-ray modality.

The registration process will be described in relation to FIGS. 9 and 10 which are taken from U.S. patent application Ser. Nos. 17/707,153 and 18/847,012, originally presented as FIGS. 1 and 2 in U.S. patent application Ser. Nos. 17/707,153 and 18/847,012. Screen Vertical Line 901 is a vertical line showing the center position projected by the imaging device to locate where the 90-degree object to camera location is drawn on a computer screen vertically. Facial Vertical Line 902 is illustrated in the center of the face and is represented by the line drawn from certain markings found on the face, for example, by an AI function or software. Upper Facial Horizontal Line 903 is illustrated on the forehead and is represented by a line drawn from certain markings identified on the face. Upper Screen Horizontal Line 904 is illustrated on the forehead and is projected by the imaging device to show the 90-degree location respective to the camera device projected horizontally. Lower Screen Horizontal Line 905 is illustrated on the screen below the Upper Screen Horizontal Line 904. The Lower Facial Horizontal Line 906, after coinciding with the Lower Screen Horizontal Line 905 to become Single Horizontal Line 909 will also be known as the Default Pitch Line, is illustrated on the facial image below the Upper Facial Horizontal Line 904 and is represented by a line produced by the software taken from facial markings. As shown in FIG. 10, when lines 901 and 902 align as line 907, lines 903 and 904 align as line 908 and lines 905 and 906 align as line 909, the face of the patient is at zero tilt.

The X-ray beam has its own center, and if the imaging/camera device cannot be positioned corresponding to the X-ray beam's center, both centers will create an angle in between them and the center of the camera and the center of the X-ray will never match. This creates imprecision and guess work in positioning before and during imaging study, as currently there is no way to manually coincide the centers during imaging procedures.

### SUMMARY

Devices, systems and methods for calibrating a center of an imaging device, such as a camera, to a center of an X-ray beam are provided.

According to one aspect of the present disclosure, a system for calibrating a center of an imaging device to a center of an X-ray generator, where the X-ray generator projects a center of an X-ray beam onto an image receptor, includes a protractor device including a horizontal leg coupled to a vertical leg via a rotating member, the horizontal leg configured to be mounted to a top surface of the X-ray generator; an imaging device disposed on the vertical leg that captures at least one image of the image receptor, the imaging device being adjusted, via the protractor device, to a zero tilt relative to the image receptor; a controller coupled to the imaging device including a wireless communication device, the controller transmits the at least one image from the imaging device to a head positioning system; and the head positioning system configured to receive the at least one image, determine the X-ray center from the at least one image using an image recognition function, determine the center of the imaging device and align the center of the imaging device to the center of the X-ray generator using an artificial intelligence (AI) function.

In one aspect, the system further includes a display that displays an angle between the horizontal leg and vertical leg.

In another aspect, the wireless communication device is a WiFi communication device.

In a further aspect, the protractor device is positioned on the X-ray generator such that the vertical leg is a predetermined distance from a surface of the X-ray generator to enable the vertical leg to accommodate caudad tilt and cephalad tilt of the X-ray generator.

In one aspect, the imaging device and controller are disposed in a housing, the housing positioned on the vertical leg.

According to another aspect of the present disclosure, a method includes projecting an X-ray beam center onto an image receptor; tilting the X-ray beam center to a desired angle; positioning X-ray beam center onto an open mouth of a patient located in front of the image receptor; compensating an angle of an imaging device to a zero tilt relative to the image receptor; calibrating a center of the imaging device to the center of the X-ray beam; and registering the patient upon aligning the center of the imaging device to the center of the X-ray beam.

In one aspect, the calibrating is performed by an artificial intelligence (AI) function.

In another aspect, the method further includes collimating the X-ray beam after positioning the X-ray beam center to reduce an area of exposure to the patient.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 illustrates an imaging/head positioning system with a camera disengagement system in accordance with an embodiment of the present disclosure;

FIG. 2 illustrates a side view of a camera disengagement system mounted on an X-ray beam generator in accordance with an embodiment of the present disclosure;

FIG. 3 illustrates a front view of a camera disengagement system mounted on an X-ray beam generator in accordance with an embodiment of the present disclosure;

FIG. 4 is a flowchart of a method for calibrating a center of an imaging device to an X-ray beam center in accordance with an embodiment of the present disclosure;

FIG. 5A illustrates patient positioning with an X-ray generator and imaging device at zero tilt in accordance with an embodiment of the present disclosure;

FIG. 5B illustrates a Cephalad X-ray bucket tilt with an imaging device at zero tilt toward an image receptor in accordance with an embodiment of the present disclosure;

FIG. 5C illustrates a Caudad X-ray bucket tilt with an imaging device as zero tilt toward an image receptor in accordance with an embodiment of the present disclosure;

FIGS. 6A-6C illustrates steps of a calibration process in accordance with an embodiment of the present disclosure;

FIG. 7 illustrates 5 degrees cephalad X-ray bucket tilt (95 degrees) while a camera center is at 0 (90 degrees) to an image receptor in accordance with an embodiment of the present disclosure;

FIG. 8 illustrates 10 degrees cephalad X-ray bucket tilt (100 degrees) while a camera center is at 0 (90 degrees) to an image receptor in accordance with an embodiment of the present disclosure;

FIG. 9 illustrates facial lines and screen lines positioned on an image of a face; and

FIG. 10 illustrates positioning of screen lines on an image of a face at zero tilt.

It should be understood that the drawings are for purposes of illustrating the concepts of the disclosure and are not necessarily the only possible configuration for illustrating the disclosure. It should be noted that the features illustrated in the drawings are not necessarily drawn to scale, and features of one embodiment may be employed with other embodiments, as the skilled artisan would recognize, even if not explicitly stated herein. Descriptions of well-known components and processing techniques may be omitted so as to not unnecessarily obscure the embodiment.

### DETAILED DESCRIPTION

Preferred embodiments of the present disclosure will be described herein below with reference to the accompanying drawings. In the following description, well-known functions or constructions are not described in detail to avoid obscuring the present disclosure in unnecessary detail.

An operator needs to use an X-ray beam tilt when he is taking C1/C2 anterior—posterior (AP) open mouth diagnostic x-rays without which the operator may be unable to capture the entire anatomy of the area. A camera device of an imaging system, such as the Smartray® system commercially available from The Smartxray, LLC of Puerto Rico, is located on the X-ray emitter (e.g., X-ray beam, X-ray bucket) of an X-ray generator and is provided for positioning controls of the patient between an X-ray emitter and an X-ray receptor. If the camera is fixed with the X-ray beam (i.e., fixed with the X-ray generator or bucket) without tilting compensation for the X-ray beam tilt, tilting of the X-ray beam would necessitate tilting of the face of a patient because the face is fixed to the camera of the imaging system (e.g., the Smartray® system) at the moment of registration before the imaging procedure started. Registration is done when the camera is at zero tilt to correspond natural patient positioning and to avoid optical distortions of the facial image.

The imaging or head position system embodied in the Smartray® system is shown and described in U.S. patent application Ser. No. 17/707,153, filed Mar. 29, 2022 (now U.S. Pat. No. 12,322,133, issued on Jun. 3, 2025) and PCT Patent Application No. PCT/US2023/016415, filed Mar. 27, 2024 (now U.S. National Phase application Ser. No. 18/847,012, filed Sep. 13, 2024), the contents of all of which are herein incorporated by reference in their entireties.

If the camera is fixed to the X-ray bucket, during tilting of the X-ray bucket, the camera is moving with the X-ray bucket provided that the face must be registered to the camera, and therefore the face is “fixed” to the camera, as well. Since the face of the patient is fixed to the camera, tilting will require the face to be re-registered to follow the camera when the camera does not provide compensation for tilting. The face when the bucket is tilted follows the tilting of the X-ray bucket with the camera since the camera is fixed on the X-ray bucket. Since the view of the face is required for positioning control while taking X-ray imaging study, and when the camera now is tilted, the face image that can be seen on the monitor field is either distorted, or moved away. This will prompt the operator to reposition the face, re-register it to bring the face within the required field proportionally to the tilt where the face would follow the tilts. The outcome would be that the tilt the purpose of which is to “bypass” certain anatomical structures would not serve its purpose because the face followed the tilt, with nothing changed, as far as bypassing these anatomical structures. The desirable diagnostic result with the desired view will not be achieved simply because nothing has changed, i.e., the face is following the positional changes of the camera sitting immovable, fixed, on the tilted X-ray bucket. Screen lines on a display of the imaging system will make the face to follow them when initial face position was obtained during facial registration, at that time, when the X-ray bucket and the camera were both at zero degrees relative to each other, since they are fixed to each other, i.e., screen lines are generated on the display to register the patient at zero tilt. When tilting is implemented for the purpose to bypass certain blocking the view anatomical structures, since both the X-ray head and the camera are repositioned, the face has to be also moved up or down, as with cephalad or caudad tilting, respectively. And unfortunately, in order to proceed with the X-ray imaging, the face has to be moved up or down in order to get those facial lines which were obtained when the face was registered with the zero tilt. When the face gets to zero tilt towards the camera, the x-ray beam is getting back at zero and tilting it did not achieve its goals, the tilting value gets annulled since nothing has changed. X-ray beam tilt is intended to take a clean, unobstructed view of Atlanto-Axial joint “under” certain anatomical obstacles which would obscure the image making it undiagnostic. For example, to bypass the front teeth requires a Cephalad tilt, or caudad tilt requiring bypassing Occipital Tuberosity image. It is therefore, for obtainment of quality diagnostic imaging while tilting of the beam, the camera controlling the face must not change its position after its registration with the Smartray® camera device which must be always at zero tilt, i.e., zero tilt means, it is parallel to the horizon, or the floor.

The devices, systems and methods of the present disclosure are constantly keeping the camera at ZERO tilt, i.e., parallel to the floor or the horizon, and the face of the patient should not be moved, as initially registered with the camera, while X-ray vectors could be manipulated. When the camera device is positioned on the X-ray lamp, the face is registered at the camera having a zero tilt and while having tilting freedom of the X-ray bucket, freedom to the camera was added, allowing the camera device to be free to move back the same degrees the bucket was tilted to compensate for the bucket tilt to allow the camera to remain at zero tilt, or parallel to the horizon. This will allow the devices, systems and methods of the present disclosure to compensate for the X-ray bucket tilting while keeping the face of a patient to be fixed to the camera without changing, or re-registrations.

X-ray bucket tilting would move the center of the camera upward or downward in cases of Cephalad or Caudad, respectively if camera is fixed on the X-ray bucket. The center of the camera must correspond to the center of the mouth of the patient, re-registering the face at the different tilts to accompany the center of the mouth will not cause any changes for the X-ray vector due to reasons described above and therefore the imaging results will be the same without changes. Another adverse event will be that, in excessive tilts, the camera center will be pointed too high in Cephalad tilts, or too low in Caudad prompting the operator to bring the face excessively up, or down to follow the center of the camera and re-register the face again, often to a point which it may not be physically possible to position the patient properly, prompting the operator to open vertical collimation and increase the field of exposure. However, the user still will get the same image results with issues like frontal teeth blocking the desired view of C1/C2, or Occipital Tuberosity line visible, since nothing would change and diagnostic imaging results will be the same with obstructed views.

It is only when camera device can be moved separately (i.e., be disengaged) from the X-ray bucket it is possible to maneuver the X-ray vector and get an unobstructed view of C1/C2. There must be freedom to tilt the camera device to be able to keep the camera device constantly at zero while the X-ray bucket can be tilted to any degree cephalad or caudad, as necessary. The devices, methods and systems allow tilting of the X-ray bucket however while the camera device is tilted the same way exactly contrary to the X-ray beam, which allows the camera tilt to be kept at zero degrees all the time therefore, allowing manipulations of the X-ray vectors before and during diagnostic imaging, or treatment procedure.

The devices, systems and method of the present disclosure enables an X-ray vector to be sent “underneath” and bypass the upper front teeth in the event of Cephalad, or bypass the Occipital Tuberosity in the event of Caudad tilt. X-ray vectors can be modified with angulation as necessary to obtain imaging study of diagnostic quality while keeping the face of the patient always stable at ZERO tilt as it was at the moment of facial registration.

To accomplish the above, the camera disengagement system of the present disclosure is directed to controllably disengage or separate the camera device from the X-ray bulb with positioning the camera of the image positioning system on an electronic protractor device. The protractor device solves the issues of tilt compensation of the X-ray bulb while allowing the camera device to be constant and not to change its degrees relative to a face of a patient.

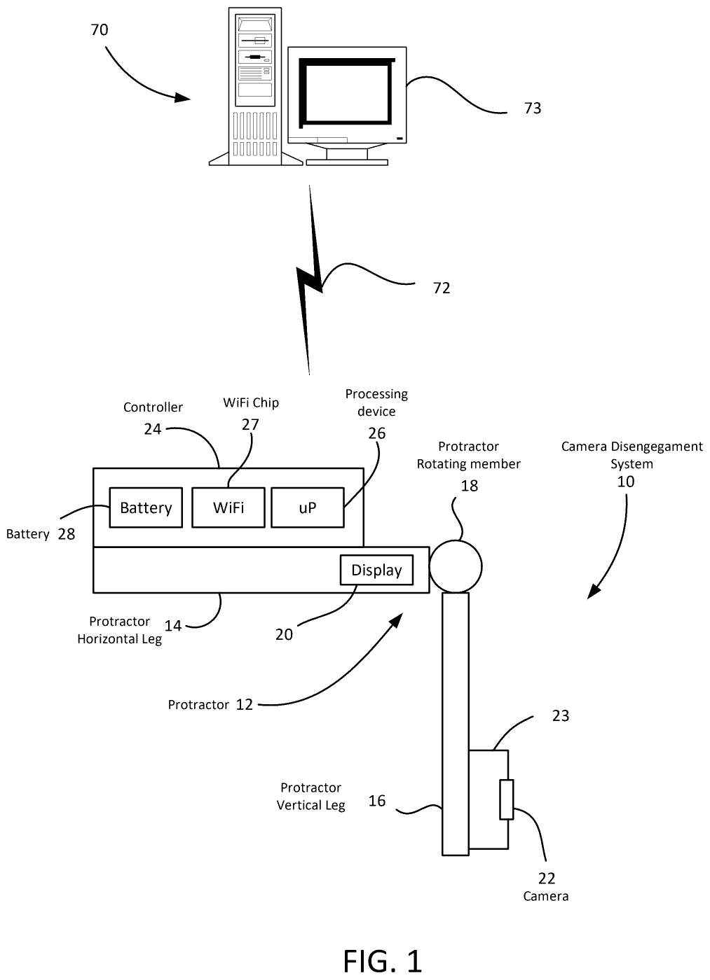

Referring to FIG. 1, an imaging/positioning system 70 and a camera disengagement system 10 is illustrated. As mentioned above, the imaging and head positioning system 70 is shown and described in U.S. patent application Ser. No. 17/707,153, PCT Patent Application No. PCT/US2023/016415 and U.S. patent application Ser. No. 18/847,012. The camera disengagement system 10 includes a protractor 12 including a horizontal leg 14 coupled to a vertical leg 16 via a rotating member 18. A display 20 is provided to display an angle between the horizontal leg 14 and vertical leg 16. The camera disengagement system 10 further includes a camera 22 disposed in an enclosure or housing 23 on a lower end of vertical leg 16. The camera 22 is in communication with controller 24. In one embodiment, the controller 24 is disposed on the horizontal leg 14. In another embodiment, the controller 24 is disposed in a housing or enclosure 23 with the camera 22. The controller 24 includes at least one processor 26 and a battery 28 for providing power to the processor 26 and camera 22. The controller 24 further includes a WiFi function to communicate over a wireless connection 72 either with regular WiFi to provide data communication on collision based protocol, or via WiFI with cellular HQ chip 27 for wireless communication to the imaging system 70 on a cellular platform on scheduled protocol for mission critical applications to allow constant uninterrupted video streams. In other embodiments, the connection 72 may be hard-wired.

AI (artificial intelligence) software is installed at the main computer level of the imaging system 70 which receives the video stream from the camera device 22. The AI software, which is a part of disengagement system, brings the camera center to be at the same point with the X-ray center, as will be described below.

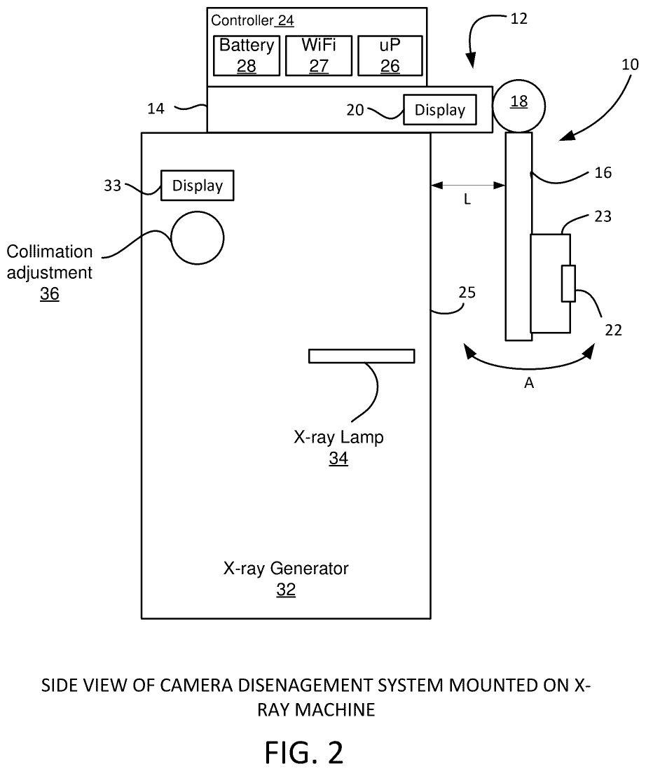

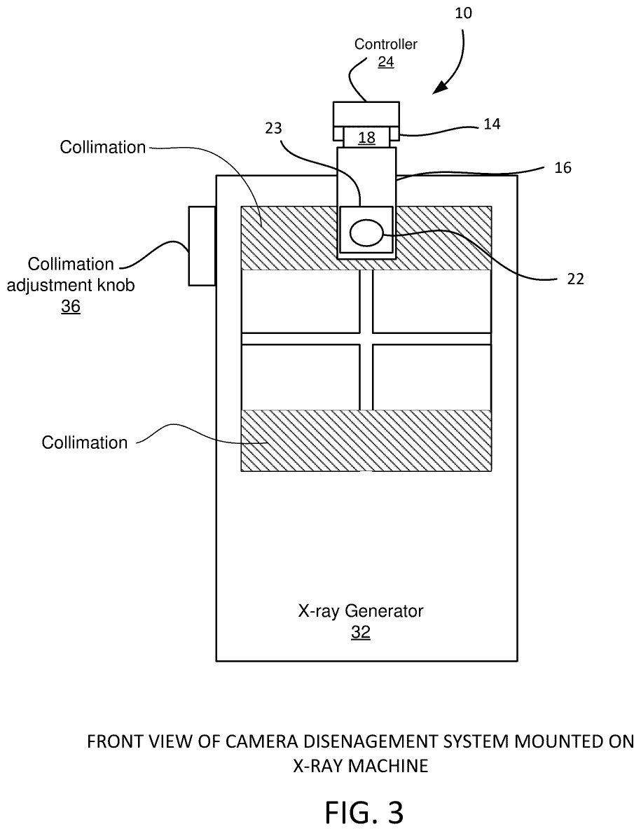

Referring to FIGS. 2 and 3, the camera disengagement system 10 is illustrated mounted to an X-ray generator or bucket 32. The X-ray generator 32 includes an X-ray lamp or bulb 34 for generating an X-ray beam and a display 33 that displays a tilt angle of the X-ray beam. A collimation adjustment knob 36 is provided to adjust the collimation area.

Camera tilt is the angle to counter the X-ray tilt. X-ray tilt can be Cephalad (upward), or Caudad (downward). Depending on the anatomy that is blocking the view, an operator selects the tilt (i.e., upward, or downward) to get an unobstructed view for the imaging study. The protractor's one leg 16 is to be positioned vertically and the other leg 14 horizontally fixed on the X-ray generator 32. It is to be appreciated that leg 14 is fixed to the X-ray generator 32 such that leg 16 is at least a distance L from a surface 25 of the X-ray generator 32. By providing distance L, the leg 16 may travel in two directions, as indicated by arrow A, to accommodate for a full range of angle rotations. The system 10 has an electronic display 20 showing the operator the degrees of the tilt of camera 22. The tilt of the camera 22 must always be constant at zero.

The X-ray beam can be of any degree tilt: cephalad, or caudad. In one embodiment, the enclosure or housing 23 located on the vertical 16 includes at least the following:
A diode that is showing that the system 10 is operational; for example, the diode may indicate system 10 is ON or OFF, if there is enough battery power and/or if the system 10 has WiFi/cellular Chip 27 connection
power connector to the power bank
Switch of the power On/Off
Camera lens must be positioned at the end of the enclosure box positioned as shown on the FIG. 1
A compass indicator that the camera is at zero as a starting point
Rapsberry Pi, or similar micro computer with WiFi communicating with Smartray® imaging computer 70 via a router. Connection to the computer 70 from camera 22 may be with Cellular Chip 5G/WiFi7 or similar that have scheduled protocols, or regular WiFi that have collision based protocols. In Regular WiFi, quality of the camera streams can be interrupted, whereas HQ Chip with WiFi 7 can provide uninterrupted camera stream for mission critical applications, like medical, which can provide 7G of data stream, basically making the videos similar to a mirror.

As an example, the camera would be registering the patient at zero tilt, i.e., perpendicular to the patient's mouth with the center of the camera directed at the patient's mouth. If the X-ray bulb is tilted at +10 degree cephalad (i.e., upwards) to capture the C1/C2 complex, then the camera positioned on the X-ray generator 32 with the electronic protractor 12 would be changed at −10 degree going back with resultant at zero tilt. Again, since the disengagement unit is on the X-ray generator 32, the camera angle would need to compensate to −10 degree to keep the camera constant at zero so that the position of the face of the patient is not changing, but only the X-ray bucket's TILT is changing for the X-ray's vector to get “UNDER” obstructing structures to produce the best unobstructed diagnostic quality image of C1/C2 articulation.

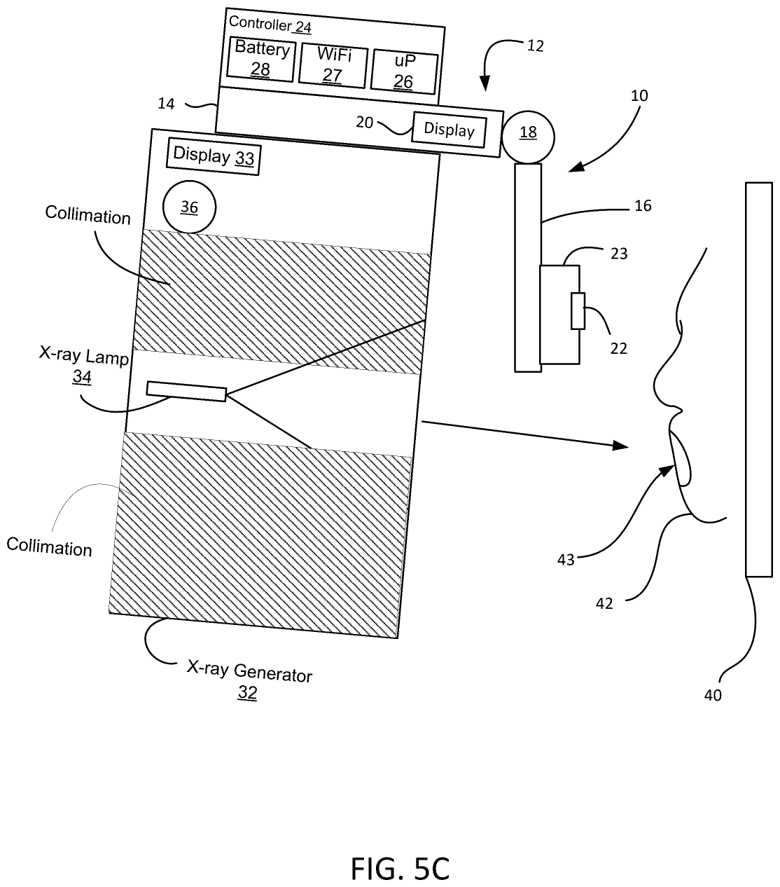

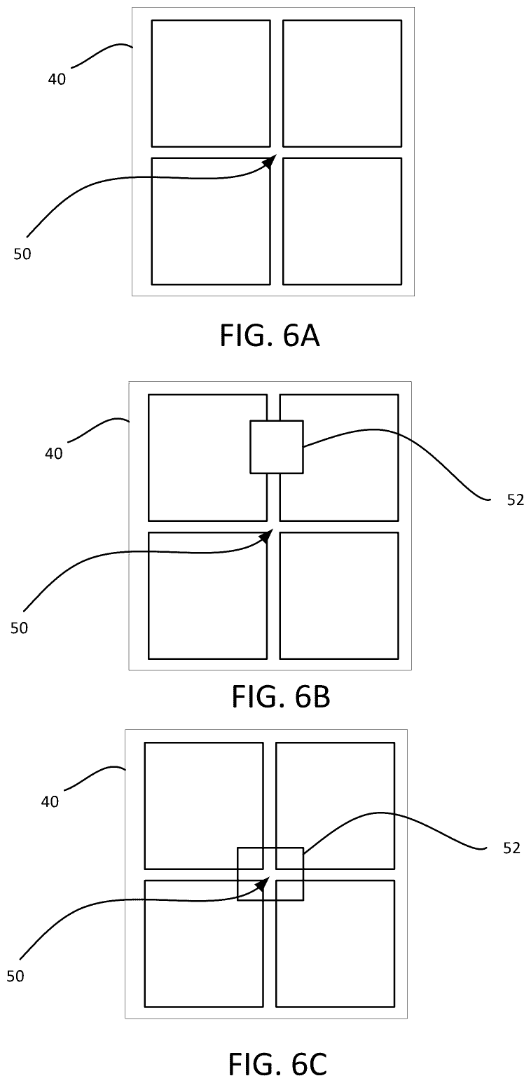

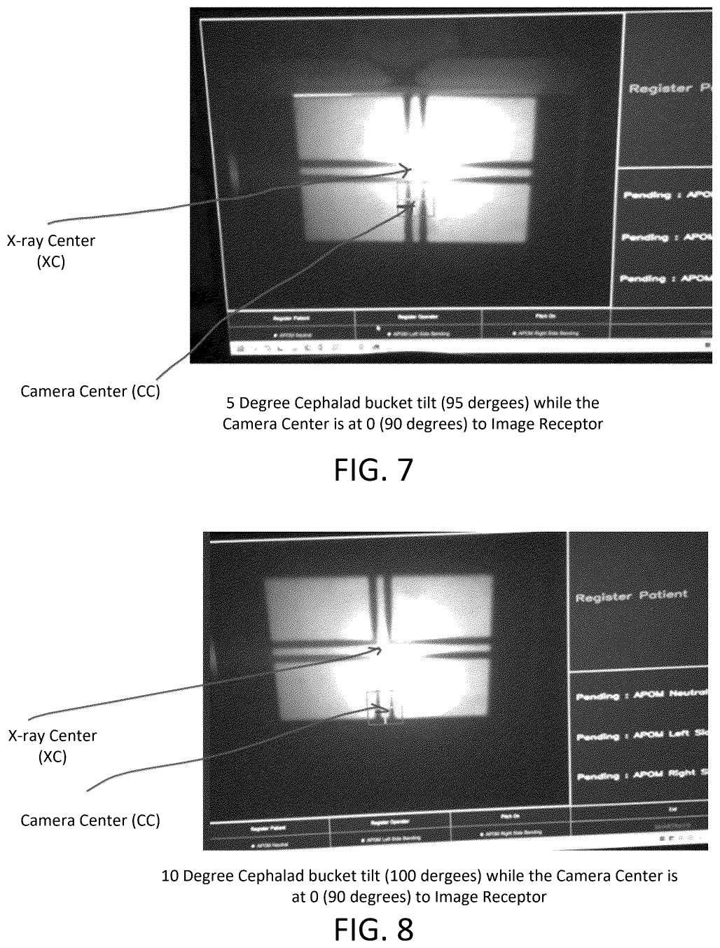

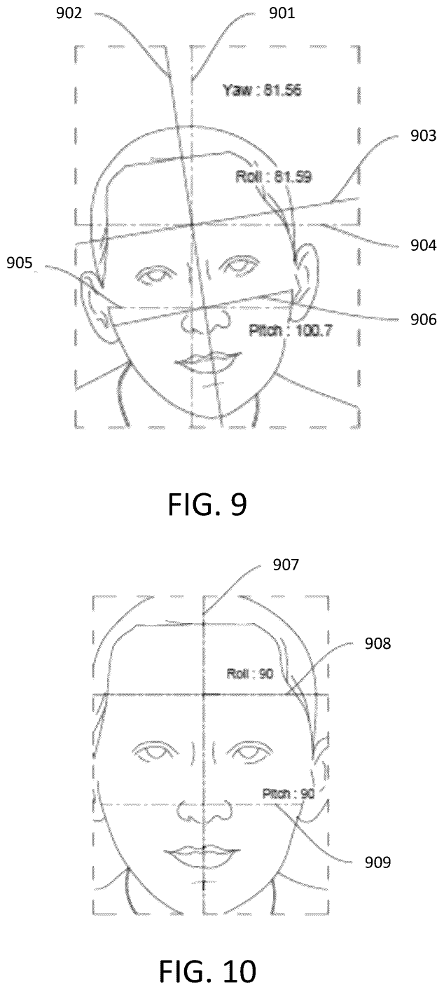

Changes in the centers for the camera and X-ray beam. When there is an X-ray beam tilt, for example cephalad +10 degrees, while camera stays at zero tilt there is another problem, the X-ray beam center has moved away from the camera center on the image receptor of the X-ray system. If that is allowed then the X-rays will land to a different area, see FIGS. 7 and 8, eventually making it impossible to position the patient because the camera center will be in one location, and the X-ray beam center will be at a different location prompting the operator to open collimation wider vertically to get to the area and with that, the operator would increase radiation exposure to the patient as the larger body area would be exposed. Since collimation is opened for both sides of the X-ray beam and cannot be opened by only one side, it increases the area on both sides, upper and lower, or right and left, magnifying X-ray exposure on the patient's body surface area to a point when to use the positioning system 70 would be too invasive and therefore would not be practical and acceptable.

Every time there is an upper (cephalad) tilt of the X-ray beam, the beam creates the X-ray target which is positioned higher than camera center, see FIGS. 7 and 8, or lower as in case with the X-ray beam tilted Caudad (not shown). In order to position the patient controllably in respect to the camera and the X-ray beam, the camera center must coincide with the X-ray beam center for both centers (i.e., the camera center and X-ray beam's center) to coincide as one. Collimation will be practical to limit unnecessary patient exposure to radiation.

In the latter case, the results were such that since the X-ray lamp was lowered but the camera was compensated to zero as it was before, it positioned the X-ray beam center at a very low position prompting the lowering of the patient, or opening wider collimation which is not practical and dangerous for the patient. Proper collimation to limit patient exposure is crucial as risks to the patient's health must be minimized.

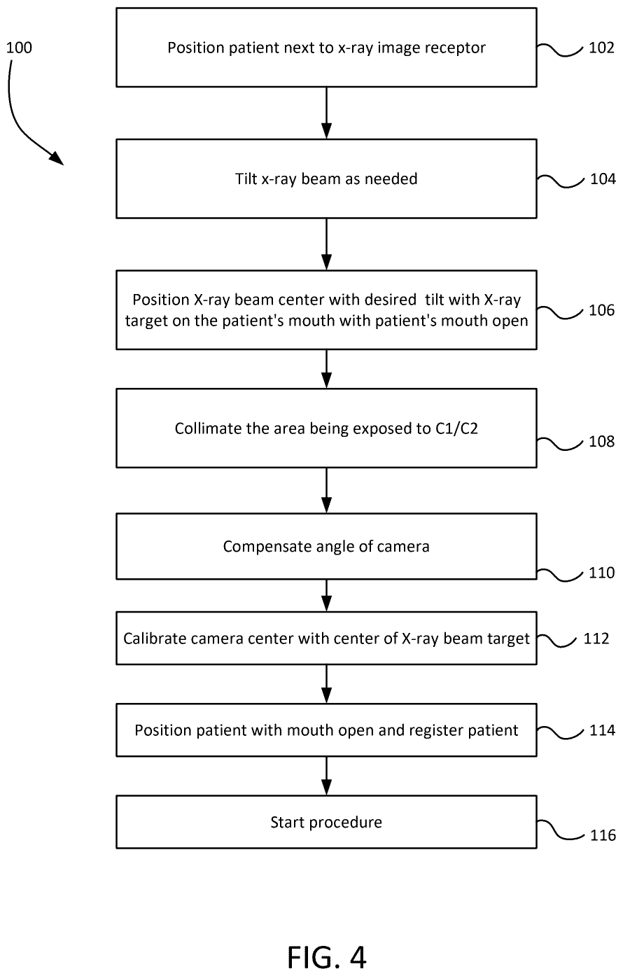

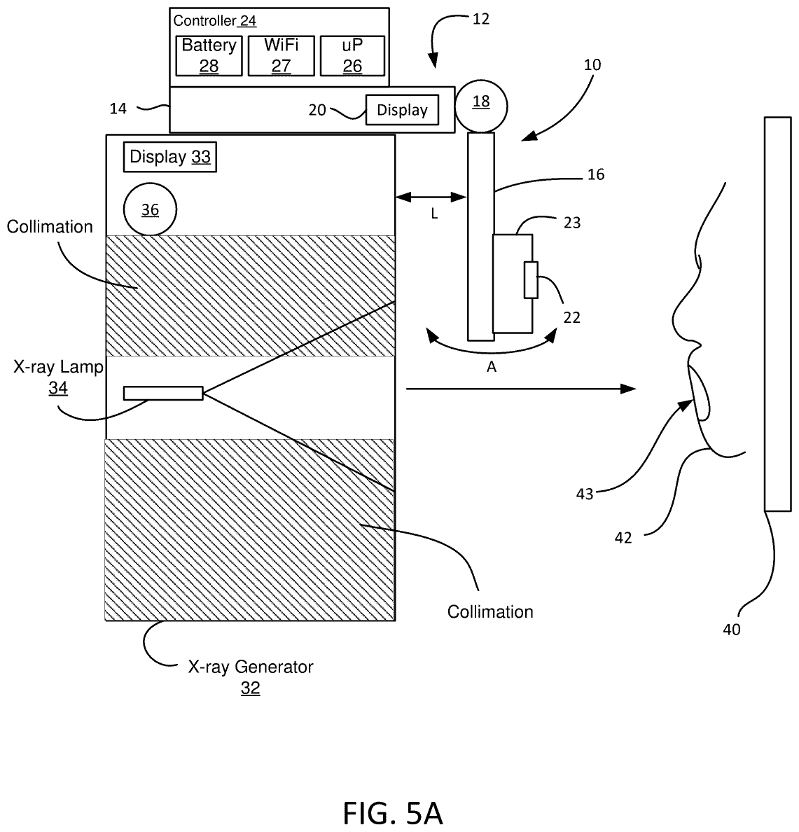

Referring to FIG. 4, a method 100 for calibrating a center of a center of an imaging device such as a camera to a center of an X-ray beam is provided. In step 102, the patient is positioned next to an image receptor 40 of the X-ray generator 32 for open mouth C1/C2 joint imaging, as shown in FIG. 5A. As shown in FIG. 5A, the patient 42 is positioned in front of the X-ray generator 32 with the image receptor 40 behind in the view of the camera 22 and X-ray beam 34, i.e., the face of the patient is facing the camera 22 and X-ray beam 34 and a back of the patient's head is facing the image receptor 40. In step 104, the X-ray beam is titled as needed. For example, tilt is usually may be determined by an initial 1^{st} image: if the front teeth are blocking the C1/C2 then it is necessary to tilt cephalad (upwards) as shown in FIG. 5B, if Occipital Bone is blocking the C1/C2 image, then the tilt must be directed Caudad (downwards) as shown in FIG. 5C. It is generally accepted standard on all open mouth X-ray image studies to start imaging at 15% Cephalad tilt when both shoulders touch the image receptor 40 (textbook). Although it is in the textbooks, it is never done since it is no way to trace how to change the tilt after the first image as the patient's positioning is not controlled. In the system and method of the present disclosure, the patient's positioning is controlled via camera disengagement system AI software, and therefore the tilting is controlled.

In step 106, the X-ray beam center is positioned with the desired tilt with the X-ray target on the patient's mouth 43, for example as shown in FIGS. 5B and 5C, with the patient's mouth open. Next, in step 108, collimate, or limit, the area of being exposed only to C1/C2. In step 110, the angle of the camera is compensated exactly against to the degrees to which the X-ray beam was tilted to make sure the camera tilt is at zero. In one embodiment, the angle of the camera is compensated manually by adjusting the vertical leg 16 relative to the horizontal leg 14. In other embodiments, the angle of the camera is compensated automatically by adjusting the vertical leg 16 relative to the horizontal leg 14 via, for example, a step motor and suitable electronics.

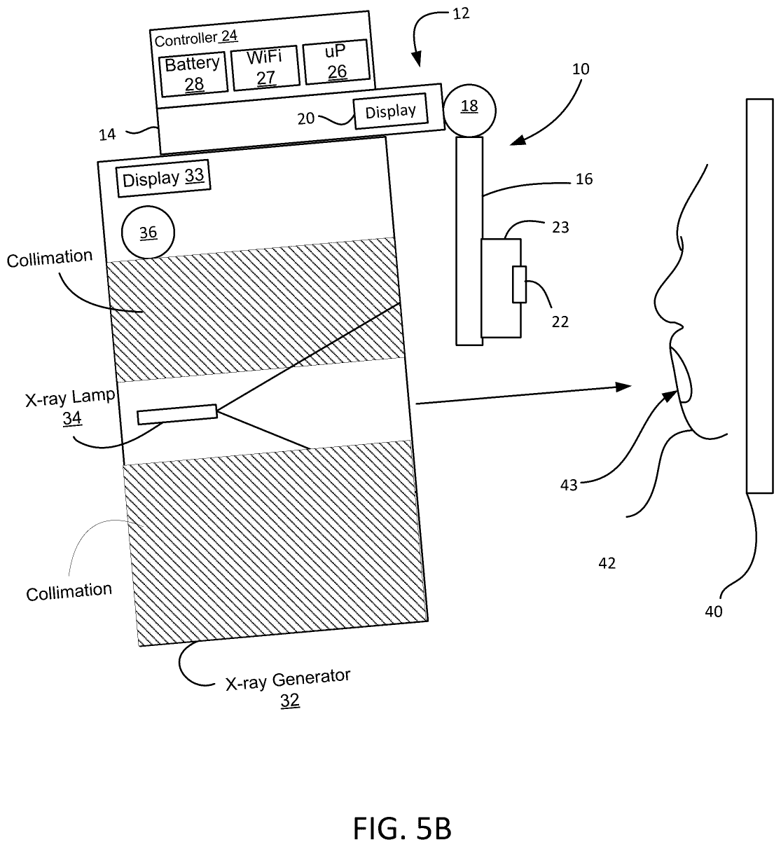

In step 112, the camera center is calibrated to the X-ray target via AI software. Referring to FIG. 6A, the X-ray target 50 is shown on the image receptor 40. In FIG. 6B, the camera center 52 is 15 degrees off from the X-ray target 50 and the centers do not coincide. In FIG. 6C, the centers 50, 52 are calibrated as shown.

The calibration process will now be explained. The X-ray center 50 is represented by a cross projected to the image receptor 40 where vertical and horizontal lines meet at some point in the center, as shown in FIG. 6A. Camera is represented via perpendicular lines forming center in the computer field of a monitor, or a computer display on the imaging system 70. AI software identifies the X-ray center (i.e., the cross' center 50 in FIGS. 6A-6C) via image recognition as X-ray beam center is represented by a cross with perpendicular lines meeting at the center. Initially, the bucket tilt is established, for example, at 15 degrees cephalad, and the X-ray center is pointed to the center of the mouth. Next, the camera center is moved −15 degrees to counter the cephalad tilt for compensation, i.e., the camera is adjusted to zero tilt for the patient's face to be within the camera field. This angular change between the two centers creates a gap distance between the X-ray center and camera center. At that point, the button “Calibrate” is clicked twice till it changes its color to green, on the user interface of the system, and the AI software recognizes the X-ray center where the vertical and horizontal lines meet while the light bulb of the X-ray bucket is pointed at the mouth, or at the image receptor, and the AI software brings the camera center within the software code to be imaged on the computer display 73 to coincide the camera center with the X-ray Center. Now, both centers are identified on a display 73 of the Smartray® imaging computer 70 in same location.

It is to be appreciated that the camera once the bucket tilt is established, say 15 degrees, is countered −15 degrees to keep it constant at ZERO degrees. From that moment the camera has not changed in its angle. It is only AI software that brings the camera center on the computer display together with the X-ray center. For example, the AI machine learning software identifies an X-ray center mark. The X-ray center mark may be a cross, or could be something else that can be seen, depending on the X-ray device. One can see that image mark when the X-ray light bulb is switched on and the bulb is projected on image receptor. Since the camera must be positioned on the X-ray bucket, the camera is also picking up the image of this mark and the operator can see the mark on the video screen/computer screen. The machine-learning algorithm identifies this shape and when it does, it brings the camera center to the same coordinates on the image screen, and visually, it can be seen “one upon another”. This is required for further facial identification because the patient face (head) is moved and images are taken in weight bearing mode, with open mouth left or right lateral neck flexion in orthogonal views, which is very important for keeping the image distortions to a minimum. This is considered the most difficult positions to image with, but required when assessing Major Stabilizing Ligaments in the Cervicocranium, or Atlanto-Axial joint. And, because (1) the center of the camera is properly positioned towards the face, (2) together with the correctly tilted X-ray beam bypassing anatomical structures which may block Atlanto-Axial joint, weight bearing Atlanto Axial Joint Major Stabilizing ligament imaging will render the best diagnostic quality result.

In step 114, the patient is positioned with their mouth open and the patient is registered, i.e., the camera tilt is zero and the two centers are aligned. In step 116, once the patient is registered, a procedure may be started.

After the patient is registered, highly technique sensitive X-ray imaging studies with open mouth neutral and open mouth weight bearing neck side bending positions can be performed to check C1 lateral mass translation over C2 for hypermobility in the C1/C2 complex. As well, visualization of Cervicocranial complex is possible for fractures and other pathology diagnoses.

Several Tests were done to understand the nature of the X-ray lamp tilt.

Test 1. If we aim at the image receptor 40 with 0 degree tilt of BOTH, the Camera Center (CC) and the X-ray Center (XC), the centers will be coinciding. If we follow the Face Registration at this time, and expose an X-ray to create an imaging study the front teeth will be blocking the Dens of C2 and lateral masses of C1. To overcome this, we need to tilt the XC upward, or cephalad, at about 7-10 degrees, or for example, even 15 degrees, disengage the camera with the camera disengagement device 10 with opposite degrees for the camera to stay at 0 degrees, then with the help of AI software to coincide the camera center with the X-ray center to make both centers into one, and then register the patient's face with open mouth for diagnostic Cervicocranial (Cervicocranial Junction) open mouth X-rays. This way we will be able to take the image with the X-ray bucket tilt managing the X-ray Vector to bypass the front upper teeth, and this only can be achieved if the face is registered at 0 degree camera TILT (i.e., camera has no tilt).

Test 2. If we aim CC (Camera Center) at the image receptor 40 with 0 degree tilt (90 degrees), but XC (X-ray Center) is at 5 degree cephalad (95 Degrees), directed from bottom to top, then the XC X-ray Center will appear higher than the CC, as shown in FIG. 7.

Test 3. Referring to FIG. 8, if we aim CC at the image receptor with 0 degree tilt (90 degrees), but XC is at 10 degree cephalad (90+10=100 Degrees), directed from bottom to top, then the XC appears to be even higher than the CC when at 5 Degrees Cephalad.

If we image C1/C2 in this position on a human face without coinciding the camera and X-ray centers we would already be pointing the X-ray center to image the forehead of the patient, and we must now enlarge collimation to increase the area of irradiation to include the center of the mouth, which is very harmful for the patient because collimation would open also the upper part and expose all patient's head.

The distances of the X-ray bucket centers between the Test 1, Test 2, and Test 3 in relation to the camera center are directly proportional to the difference of the tilt degrees of the X-ray bucket. The same rationale will apply to the relational changes of CC and XC which will be seen with Caudad tilts (opposite to the Cephalad) with one difference that the XC will be lower than CC with −5 (85), −10 (80), etc. If we want to image Dens of C1/C2 perfectly, we have to keep the face of the patent to the CC at 0 degree with the Camera Disengagement Device while employing X-ray bucket tilts as required. After coinciding of both centers, patient registration is followed with diagnostic imaging studies.

To repeat, when the XC tilt is done, the CC would be adjusted by camera disengagement device to counter degrees to keep the CC at 0 degree tilt relative to the image receptor 40, and then with the use of an AI software, the CC is moved to XC to coincide the CC with the XC pointed at the center of the patient's opened mouth, and after that we will be registering the patient's face with the mouth opened recording this patient's positioning in the system as initial registration from which we can control precise patient's head positioning

It is to be appreciated that the various features shown and described are interchangeable, that is a feature shown in one embodiment may be incorporated into another embodiment.

While the disclosure has been shown and described with reference to certain preferred embodiments thereof, it will be understood by those skilled in the art that various changes in form and detail may be made therein without departing from the spirit and scope of the disclosure.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

What is claimed is:

1. A system for aligning a center of an imaging device to a center of an X-ray beam projected by an X-ray generator, comprising:
an imaging device configured to capture at least one image of an image receptor upon which the X-ray beam is projected;
a protractor assembly configured to mount the imaging device to the X-ray generator, the protractor assembly including:
a horizontal leg fixed to the X-ray generator;
a vertical leg rotatably coupled to the horizontal leg;
a controller coupled to the imaging device, the controller comprising:
a processor;
a wireless communication interface; and
memory storing instructions executable by the processor;
an artificial intelligence (AI) module in communication with the controller, the AI module configured to:
receive the at least one image from the imaging device;
identify, using image recognition, a center of the X-ray beam within the image;
determine a center of the imaging device within the image; and
align the center of the imaging device to coincide with the center of the X-ray beam in the image.

2. The system of claim 1, wherein the AI module is further configured to display visual indicators of both the X-ray beam center and the imaging device center on a graphical user interface.

3. The system of claim 1, wherein the AI module performs calibration by adjusting image coordinates of the imaging device center on the system display until alignment with the X-ray beam center is visually confirmed.

4. The system of claim 1, wherein the imaging device and the controller are housed in a single enclosure mounted to the vertical leg of the protractor assembly.

5. The system of claim 1, further comprising a calibration interface including a user-activated control element configured to initiate AI-based alignment upon input.

6. The system of claim 1, wherein the X-ray beam center is identified based on detection of a cross-shaped or line-shaped marker projected by the X-ray generator onto the image receptor.

7. The system of claim 1, wherein the wireless communication interface includes a high-bandwidth WiFi or 5G chip configured for uninterrupted transmission of imaging data.

8. The system of claim 1, further comprising a tilt sensor configured to provide feedback to ensure the imaging device remains at a zero-degree tilt relative to the image receptor during calibration.

9. The system of claim 1, wherein the AI module is embedded in a head positioning system that uses the aligned centers for patient registration and guided X-ray imaging procedures.

10. The system of claim 1, further comprising a motor operatively coupled to the protractor assembly and configured to automatically rotate the vertical leg to counteract the tilt of the X-ray generator.

11. The system of claim 10, wherein the controller includes a tilt sensor configured to detect the tilt angle of the X-ray generator and generate a corresponding compensation signal.

12. The system of claim 11, further comprising a display configured to show the tilt angle of the X-ray generator and the compensated tilt angle of the imaging device in real time.

13. The system of claim 10, wherein the motor is a stepper motor configured to adjust the tilt in discrete angular increments for high precision alignment.

14. A method for calibrating a center of an imaging device to a center of an X-ray beam projected by an X-ray generator onto an image receptor, the method comprising:
projecting the X-ray beam center onto the image receptor;
tilting the X-ray beam to a desired angle to align with a target anatomical feature;
compensating an angle of the imaging device mounted to the X-ray generator to maintain a zero tilt relative to the image receptor;
capturing at least one image of the X-ray beam center projected onto the image receptor;
transmitting the at least one image to a head positioning system;
determining, using artificial intelligence (AI), the X-ray beam center and a center of the imaging device from the at least one image;
aligning the center of the imaging device to the X-ray beam center using the AI; and
registering a patient with the imaging device once the centers are aligned.

15. The method of claim 14, further comprising mounting the imaging device to a vertical leg of a protractor device, the vertical leg being rotatable relative to a horizontal leg fixed to the X-ray generator.

16. The method of claim 14, wherein the compensating step includes rotating the vertical leg of a protractor device in a direction opposite to the tilt of the X-ray beam to maintain the imaging device at zero tilt.

17. The method of claim 14, further comprising providing wireless transmission of the at least one image from the imaging device to the head positioning system using a WiFi or cellular communication module.

18. The method of claim 14, further comprising collimating the X-ray beam after positioning the X-ray beam center on a target anatomy to reduce unnecessary radiation exposure.

19. The method of claim 14, wherein the aligning step further comprises adjusting the displayed image center of the imaging device via a software interface until it coincides with the identified X-ray beam center.

20. The method of claim 14, further comprising activating a calibration function within the software interface, wherein the calibration is visually confirmed by coinciding crosshair markers of the X-ray center and the imaging center.

21. The method of claim 14, further comprising:
detecting the tilt angle of the X-ray generator using a sensor;
automatically actuating a motorized protractor mechanism to rotate the imaging device in an opposite direction of the X-ray generator tilt to maintain the imaging device at zero tilt relative to the image receptor;
verifying zero tilt of the imaging device using a tilt sensor; and
transmitting at least one image from the imaging device to the head positioning system for patient registration.

22. The method of claim 21, wherein the sensor used to detect the X-ray generator tilt is an electronic gyroscope or digital inclinometer.

23. The method of claim 21, wherein the protractor mechanism comprises a stepper motor configured to rotate a vertical leg of the protractor to offset the X-ray generator tilt.

24. The method of claim 21, wherein the verifying step includes comparing sensor output from the imaging device tilt sensor to a preset zero-tilt reference stored in memory.
